(19) United States
(12) Patent Application Publication
(10) Pub. No.: US 2006/0262665 A1
(43) Pub. Date: Nov. 23, 2006

(54) System and method to store and output print data using a network

(75) Inventor: Young-taek Cho, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/438,074

(22) Filed: May 22, 2006

(30) Foreign Application Priority Data
May 21, 2005 (KR) 2005-42773

(51) Int. Cl. H04B 1/20

(52) U.S. Cl. 369/1

(57) ABSTRACT

A system and method to store and ouput print data using a network, the system including a storage unit to store storage information that comprises print data and a tracking code of the storage information specifying the location of the storage information, an interface unit to transmit or receives the print data and the storage information, a control unit to issue a request for the print data using the interface unit and the tracking code of the storage information and to control a receiving of the print data, and an output unit to output the print data.

### CROSS-REFERENCE TO RELATED APPLICATIONS

This application claims priority under 35 U.S.C. §119(a) from Korean Patent Application No. 10-2005-0042773, filed on May 21, 2005, in the Korean Intellectual Property Office, the disclosure of which is incorporated herein in its entirety by reference.

### BACKGROUND OF THE INVENTION

1. Field of the Invention

The present general inventive concept relates to a system and method to store and otuput print data, and more particularly, to a system and method to store and output print data using a network.

2. Description of the Related Art

FIG. 1 is a schematic diagram illustrating a conventional method of storing print data in a server. Referring to FIG. 1, when a host issues a print command to a printer, the printer prints a document to be printed and stores print data in a server.

In detail, a network manager or a user registers a server, to which the print data is to be transmitted, with the printer. After the printer prints the document to be printed, a transmitter of the printer transmits the print data for the document to be printed and print operation information to the server registered with the printer together with a serial number of the printer.

The server registered with the printer analyzes the print data and the print operation information received from the printer and stores the analyzed results in a predetermined area in the server allotted for the serial number received from the printer.

Therefore, when the network manager or the user wishes to know how much of the document to be printed has been printed or issues a request to reprint the document to be printed, the server may transmit the print data stored therein to the printer, and the printer may print using the print data received from the server.

FIG. 2 is a schematic diagram illustrating a conventional method of storing print data in a printer. Referring to FIG. 2, when a host issues a print command, a printer prints a document and stores print data in a hard disc installed therein.

In conventional methods of storing and outputting print data, a storage device and an output device may not be compatible with each other, and thus, the output device may not be able to print data stored in the storage device unless the print data is stored therein or in a server connected thereto via a network.

Therefore, it is necessary to develop a system and a method that enable one device to read print data stored in another device, e.g., a printer, and to print the read print data.

### SUMMARY OF THE INVENTION

The present general inventive concept provides a system and method to store and output print data using a network, in which document storage information is generated when storing a document and thus the document can be read from where it is stored and then output using the generated document storage information.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a system to store and output print data using a network, including a storage unit to store storage information that comprises the print data and a tracking code of the storage information specifying a location of the storage information, an interface unit to transmit or receive the print data and the storage information, a control unit to issue a request for the print data through the interface unit using the tracking code of the storage information and to control the receiving of the print data through the interface unit, and an output unit to output the print data.

The storage unit may be located in one of a device connected to the control unit through the network and a device in which the control unit is located.

The tracking code may be written in one of a document and a printer job language.

The tracking code may be code into which device identification information, a network address specifying a device storing the print data, and document identification information specifying a document containing the print data are encoded.

The code may be encrypted.

The system may also include an input unit to receive the code, and the input unit can manually or automatically receive the code.

The input unit may receive the code by automatically reading the code using a scanner.

The system may also include an extraction unit to extract the device identification information, the network address, and the document identification information from the received code when the code is received, in which the control unit issues a request for a document corresponding to the extracted document identification information to a device corresponding to the extracted network address and the extracted device identification information and controls the requested document to be received by the interface unit.

The storage information may also include a function field specifying how to handle the print data, and the output unit may determine whether to print the print data or transmit the print data using a facsimile line with reference to the function field.

The system may also include a host to generate storage information that comprises the print data, a function field specifying how to handle the print data, a storage field specifying whether the print data is stored, and the tracking code specifying the location of the print data, in which the storage unit stores the print data and the storage information in a location specified by the storage field.

The host may generate the storage information using one of a printer driver and an application program.

The output unit may output the code together with the print data.

The foregoing and/or other aspects and utilities of the present general inventive concept may also be achieved by providing a method of storing and outputting print data using a network, including storing storage information that comprises print data and tracking code of the storage information specifying the location of the storage information, issuing a request for the print data with reference to the tracking code and controlling a receiving of the print data, and outputting the print data.

The tracking code may be written in one of a document and a printer job language.

The tracking code may be code into which device identification information, a network address specifying a device storing the print data, and document identification information specifying a document containing the print data are encoded.

The code may be encrypted.

The method may also include manually or automatically receiving the code between the storing of the storing information and the issuing of the request for the print data.

The automatically receiving the code can include automatically reading the code using a scanner.

The method may also include extracting device identification information, a network address, and document identification information from the received code between the storing of the storing information and the issuing of the request for the print data if the code is received, in which the issuing of the request for the print data includes allowing a device corresponding to the extracted network address and the extracted device identification information to search for and read a document corresponding to the extracted document identification information.

The storage information may also include a function field specifying how to handle the print data, and the outputting of the print data can include printing the print data or transmitting the print data using a facsimile line with reference to the function field.

The outputting of the print data may include outputting the tracking code together with the print data.

The foregoing and/or other aspects and utilities of the present general inventive concept may also be achieved by providing a computer-readable recording medium storing a computer program to execute a method of storing and outputting print data using a network, the method including storing storage information that comprises print data and tracking code of the storage information specifying the location of the storage information, issuing a request for the print data with reference to the tracking code and controlling a receiving of the print data, and outputting the print data.

The foregoing and/or other aspects and utilities of the present general inventive concept may also be achieved by providing a system to store and output data using a network, including a storage unit connected to the network to store the data and to generate storage information corresponding to the stored data, a control unit to control transmission of the stored data based on the storage information, and an output unit to output the stored data based on the storage information.

The storage unit can include at least one of a host, a server, a printer, a facsimile machine, and a scanner. The storage information can include a function field indicating whether to transmit the data and how to transmit the data, a storage field to indicating whether to store the data, and tracking code to indicating a location of the data.

The function field can include a first setting indicating that the data is not to be transmitted, a second setting indicating that the data is to be transmitted using a printer, a third setting indicating that the data is to be transmitted using a facsimile line, or a fourth setting indicating that the data is to be transmitted to a device in response to a request from the device for the data. The storage field can include a first setting indicating that the storage field is not used, a second setting indicating that the data is to be stored in the storage unit, a third setting indicating that the data is not to be stored in the storage unit, or a fourth setting indicating that the storage unit is used to search for the data and to transmit the data to a device in response to a request from the device for the data. The tracking code can include first information identifying a device storing the data, second information identifying the data, and third information identifying a network address of the device storing the data.

The foregoing and/or other aspects and utilities of the present general inventive concept may also be achieved by providing a method of storing and outputting data using a network, including generating storage information corresponding to stored data, analyzing identification and location information of input print data of a document to be printed, determining whether the analyzed identification and location information corresponds to the storage information of the stored data, and outputting the stored data when the analyzed identification and location information corresponds to the storage information of the stored data.

The foregoing and/or other aspects and utilities of the present general inventive concept may also be achieved by providing a method of storing and outputting data using a network, including transmitting print data and corresponding storage information to a storage unit, storing the print data in the storage unit and generating a tracking code corresponding to the stored print data, transmitting the tracking code to at least one network device, and outputting the print data using an output device. The at least one network device can be a host or a printer. The output device can include the storage unit. The output device can be the at least one network device.

The foregoing and/or other aspects and utilities of the present general inventive concept may also be achieved by providing a method of outputting data using a network, including receiving and analyzing a tracking code associated with print data to be printed, locating the print data to be printed from a storage unit using the tracking code, and outputting the print data to be printed using an output device. The output device can include the storage unit.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic diagram illustrating a conventional method of storing print data in a server;

FIG. 2 is a schematic diagram illustrating a conventional method of storing print data in a printer;

FIG. 3 is a block diagram of a system to store and output print data using a network, according to an exemplary embodiment of the present general inventive concept;

FIG. 4 is a flowchart illustrating a method of storing and outputting print data using a network, according to an exemplary embodiment of the present general inventive concept;

FIG. 5 is a flowchart illustrating an example of an operation of the system of FIG. 3 when storage information and print data are received from an external interface; and

FIG. 6 is a flowchart illustrating another example of an operation of the system of FIG. 3 when code is input by an input unit of FIG. 3;

FIG. 7 is a diagram illustrating storing of a document in a storage unit of a server and generating of code by the server, according to an exemplary embodiment of the present general inventive concept;

FIG. 8 is a diagram illustrating receiving of code by a host or a printer and printing of a document corresponding to the code stored in a server by the host or the printer, according to an exemplary embodiment of the present general inventive concept;

FIG. 9 is a diagram illustrating storing of a document in a storage unit of a printer and generating of code by the printer, according to an exemplary embodiment of the present general inventive concept;

FIG. 10 is a diagram illustrating receiving of code by a printer having a storage unit and printing of a document by the printer, according to an exemplary embodiment of the present general inventive concept;

FIG. 11 is a diagram illustrating storing of a document in one printer having a storage unit of a plurality of printers and generating of code by the printer having the storage unit, according to an exemplary embodiment of the present general inventive concept;

FIG. 12 is a diagram illustrating receiving of code by a host or a printer not having a storage unit and printing of a document read out from a printer having a storage unit, according to an exemplary embodiment of the present general inventive concept; and

FIG. 13 is a diagram illustrating generating of code information into which storage information is encrypted, according to an exemplary embodiment of the present general inventive concept.

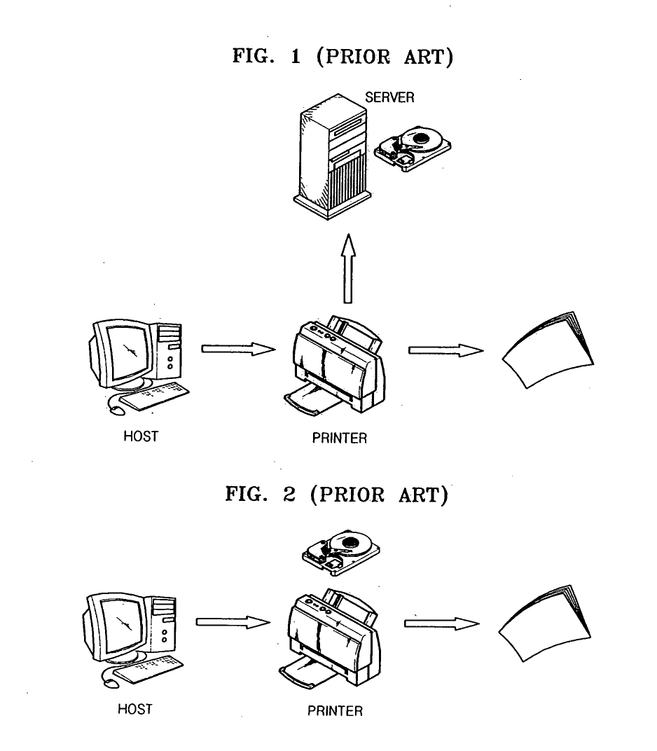

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

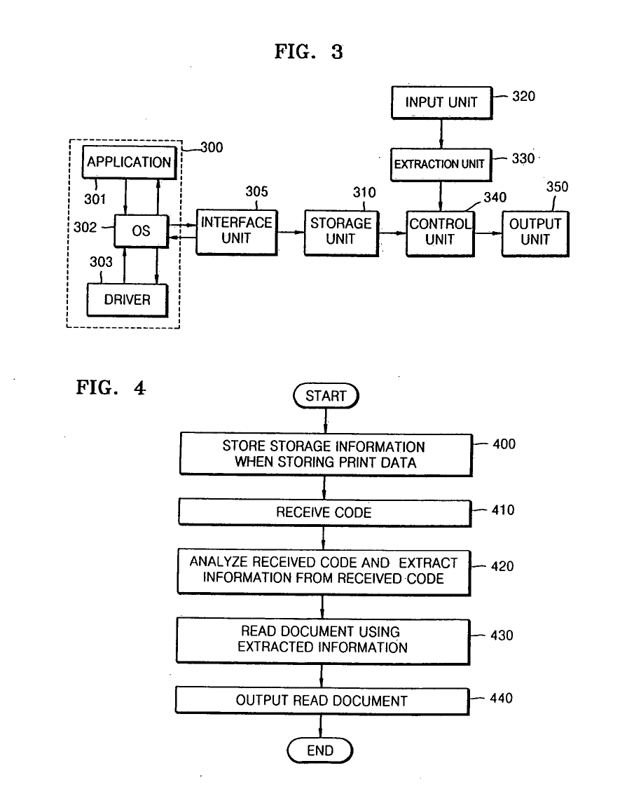

FIG. 3 is a block diagram of a system to store and output print data using a network, according to an exemplary embodiment of the present general inventive concept. Referring to FIG. 3, the system includes a storage unit 310, a control unit 340, and an output unit 350.

The storage unit 310 stores a document (print data of a document) and generates storage information. Generally, a device having a storage function can store a document. Thus, a host, a server, a printer, a facsimile, or a scanner equipped with a hard disc or a memory can be used as the storage unit 310 as long as it is connected to a network. The storage information includes a function field specifying how to handle print data generated from the document, a storage field specifying whether the print data is stored, and a tracking code specifying the location of the print data.

In detail, the function field is used to determine whether to print the print data or to transmit the print data using a facsimile line. In other words, it is determined whether to transmit the print data using a facsimile line or to print the print data based on the function field when transmitting or receiving the print data. For example, the function field may be set to one of ‘Disable,’ ‘Print,’ ‘Fax,’ and ‘Data.’ If the function field is set to ‘Disable,’ the print data is not used. If the function field is set to ‘Print,’ the print data is printed. If the function field is set to ‘Fax,’ the print data is transmitted using a facsimile line, in which case, additional information, such as a phone number to which the print data is to be transmitted, is necessary. If the function field is set to ‘Data,’ the print data is used as search response data.

The storage field is used to determine whether to store the print data. The storage field may be set to one of ‘Disable,’ ‘Save_request,’ ‘Save_deny,’ and ‘Find_request.’ If the storage field is set to ‘Disable,’ it appears that a user does not wish to store a document, and thus the storage field is not used. However, even if the storage field is set to ‘Disable,’ the document can be stored in a device having a storage function according to a predetermined specification of the device having the storage function by a host and/or a server. If the storage field is set to ‘Save_request,’ the print data is stored. If the storage field is set to ‘Save_deny,’ it appears the print data has already been stored somewhere and thus does not need to stored again, thereby preventing the print data from being stored more than one time. If the storage field is set to ‘Find_request,’ the storage field may be used to search for a document and to transmit the searched document to a device that has issued a search request for the document.

The tracking code is code into which device identification (ID) information, a network address, and document ID information are encoded. The device ID information may be a specific ID number designating a device storing a predetermined document. The document ID information may be a specific ID number allotted to the predetermined document by the device storing the predetermined document. The network address is an address in a network at which the device storing the predetermined document is accessible.

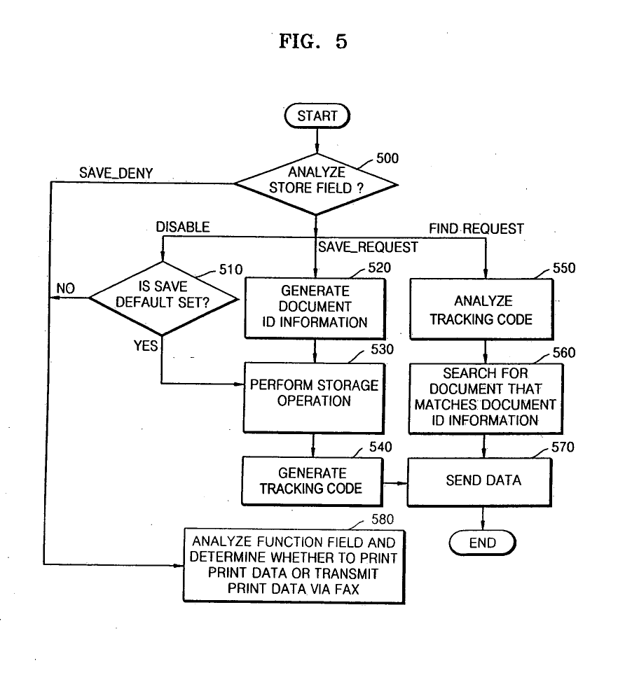

FIG. 5 is a flowchart illustrating an example of an operation of the system of FIG. 3 when storage information and print data are received from an external interface. Referring to FIG. 5, in operation 500, when the system receives storage information, it analyzes a storage field of the received storage information.

If the storage field is determined in operation 500 to be set to ‘Save_deny,’ the system performs a print operation or a fax operation in operation 580 by analyzing a function field of the received storage information without storing the storage field.

If the storage field is determined in operation 500 to be set to ‘Disable,’ the system identifies a field Save_default in operation 510. In operation 510, if the field Save_default shows that the storage field has not yet been set as a default, the system performs a print operation or a fax operation in operation 580 by analyzing the function field of the received storage information without storing the storage field. On the other hand, in operation 510, if the field Save_default shows that the storage field has been set as a default, the system stores default document ID information in the storage unit 310 in operation 530. Thereafter, the system generates a tracking code in operation 540 and transmits the generated tracking code to a host in operation 570.

If the storage field is determined in operation 500 to be set to ‘Save_request,’ the system generates document ID information in operation 520 and stores the generated document ID information in the storage unit 310 in operation 530. Thereafter, the system generates a tracking code in operation 540 and transmits the generated tracking code to a host in operation 570.

If the storage field is determined in operation 500 to be set to ‘Find_request,’ the system analyzes a tracking code in operation 550, searches the storage unit 310 for a document that matches document ID information obtained from the tracking code in operation 560, and transmits the document to a device that has issued a request for the document in operation 570.

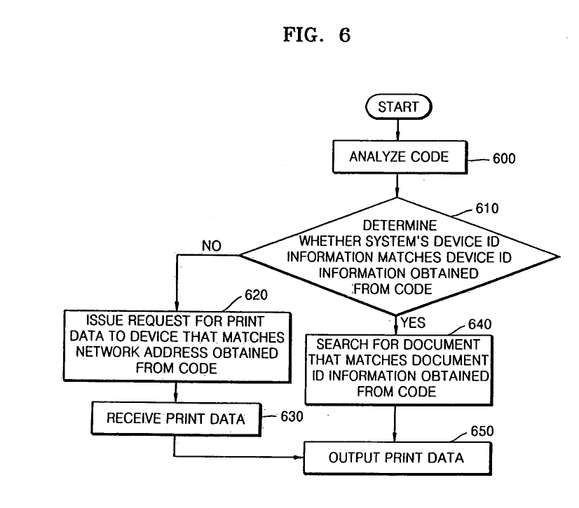

FIG. 6 is a flowchart illustrating another example of an operation of the system of FIG. 3 when code is received by the input unit 320. Referring to FIG. 6, in operation 600, the system of FIG. 3 receives code and analyzes the received code. In operation 610, device ID information obtained from the received code is compared with device ID information of the system of FIG. 3.

If the device ID information obtained from the received code is determined to be different from the device ID information of the system of FIG. 3 in operation 610, the system of FIG. 3 issues a request for print data to a device that matches a network address obtained from the analyzed code in operation 620. In operation 630, the system of FIG. 3 receives print data from the device that matches the network address. In operation 650, the system of FIG. 3 prints the received print data or transmits the received print data using a facsimile line.

If the device ID information obtained from the received code is determined to be identical to the device ID information of the system of FIG. 3 in operation 610, the system of FIG. 3 searches the storage unit 310 for a document that matches document ID information obtained from the received code in operation 640. Thereafter, in operation 650, the system of FIG. 3 prints the searched print data or transmits the searched print data using a facsimile line.

Referring to FIG. 3, the system may also include a host 300 and an interface unit 305. The host 300 generates storage information that includes the print data, the function field, the storage field, and the tracking code, and may include an application program 301, an operating system (OS) 302, and a printer driver 303. The host 300 may designate a device in which a predetermined document is to be stored using the storage information. The host 300 may display a list of devices that are connected to the network and can store documents therein, and a user may choose one of the listed devices.

The interface unit 305 transmits or receives the print data and the storage information.

The control unit 340 controls the issuing of a request from the host 300 for the print data stored in the storage unit 310 and/or controls the receiving of the requested print data by the host 300 based on the tracking code of the storage information using the interface unit 305.

Referring to FIG. 3, the system may also include the input unit 320 and an extraction unit 330.

When outputting a document (print data of a document to be printed) with reference to storage information, the input unit 320 receives code of print data stored in a predetermined storage device (not illustrated). In addition, the input unit 320 can provide a user input interface (not illustrated) by determining how to use a received document, in other words, by determining whether to print the received document or to transmit the received document using a facsimile line based on the received code.

The extraction unit 330 analyzes the code received by the input unit 320 and extracts device ID information, a network address, document ID information of a document to be printed as the analysis results. Then, the control unit 340 controls the document to be printed to be read from a storage device corresponding to the extracted device ID information and the extracted network address.

The output unit 350 outputs the document to be printed (print data of the document to be printed). In detail, when the control unit 340 receives the document to be printed using the code received by the input unit 320, the output unit 350 analyzes a function field of the storage information regarding the document to be printed and then determines whether to print the document to be printed or to transmit the document to be printed using a facsimile line based on the analysis results.

If the input unit 320 also receives the function field of the storage information together with the code of the print data, it is possible to determine whether to print the print data or to transmit the print data using a facsimile line with reference to the received function field.

The storage unit 310, the control unit 340, and the output unit 350 may be realized as independent units connected to a network. All of a plurality of devices that can be included in the system of FIG. 3 use the same communication protocols, the same data formats, and the same data processing methods and are compatible with one another.

FIG. 4 is a flowchart illustrating a method of storing and outputting print data using a network, according to an exemplary embodiment of the present general inventive concept. Referring to FIGS. 3 and 4, in operation 400, the storage unit 310 generates storage information regarding a document while storing the document therein. The storage information includes a function field, a storage field, and a tracking code of print data. The tracking code is code into which device ID information, document ID information, and a network address are encoded.

In operation 410, the input unit 320 receives code of a document to be printed in order to print the document to be printed using the storage information. In operation 420, the extraction unit 330 analyzes the code received by the input unit 320 and extracts the device ID number, the network address, and the document ID information from the analyzed code.

In operation 430, the control unit 340 controls a document corresponding to the extracted document ID information to be read from a device corresponding to the extracted network address and the extracted device ID information.

In operation 440, the output unit 350 outputs the read document. In detail, the output unit 350 may print the read document or transmit the read document using a facsimile line with reference to the function field of the storage information.

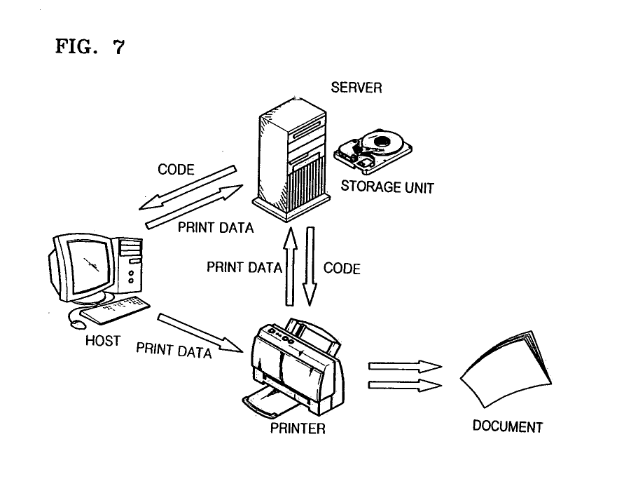

FIG. 7 is a diagram illustrating storing of a document in a storage unit of a server and generating of code by the server, according to an exemplary embodiment of the present general inventive concept. Referring to FIG. 7, a host generates print data and transmits the print data to the server together with storage information. Alternatively, the host transmits the print data to the printer, and the printer transmits the print data transmitted by the host to the server. Then, the server stores the print data transmitted by the host or the printer, generates code, and transmits the code to the host and the printer. The printer adds the code generated by the server to the print data and then prints the print data as a document.

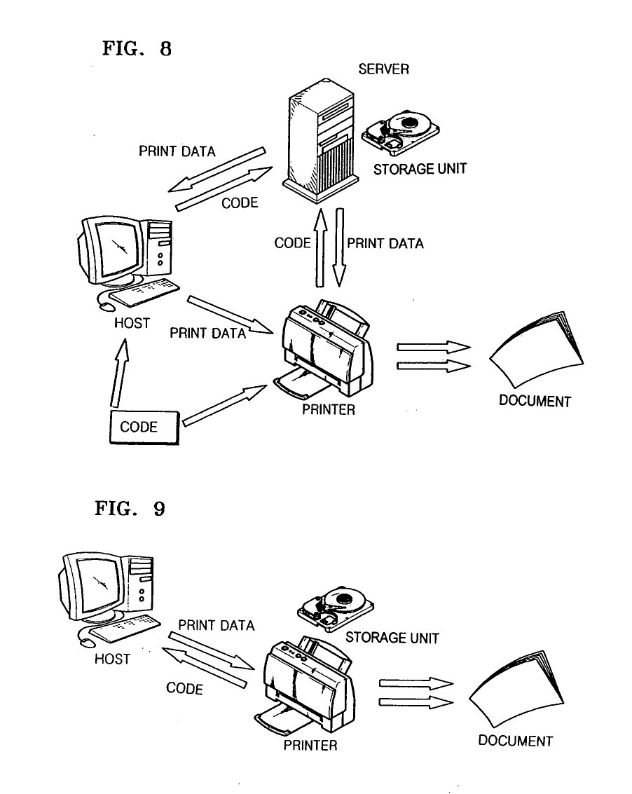

FIG. 8 is a diagram illustrating receiving of code by a host or a printer and printing of a document (print data of a document) corresponding to the code stored in a server by the host or the printer, according to an exemplary embodiment of the present general inventive concept. Referring to FIG. 8, an input unit of the host or the printer receives the code. Then, the host or the printer analyzes the received code, extracts device ID information, a network address, and document ID information from the received code, reads print data corresponding to the extracted document ID information from a device corresponding to the extracted network address and the extracted device ID information (e.g., the server), and prints the read print data as a document.

FIG. 9 is a diagram illustrating storing of a document in a storage unit of a printer and generating of code by the printer, according to an exemplary embodiment of the present general inventive concept. Referring to FIG. 9, a host generates print data and transmits the print data to the printer together with storage information. Then, the printer stores the print data therein, generates code, and transmits the code to the host. The printer may print the print data stored therein together with the code as a document.

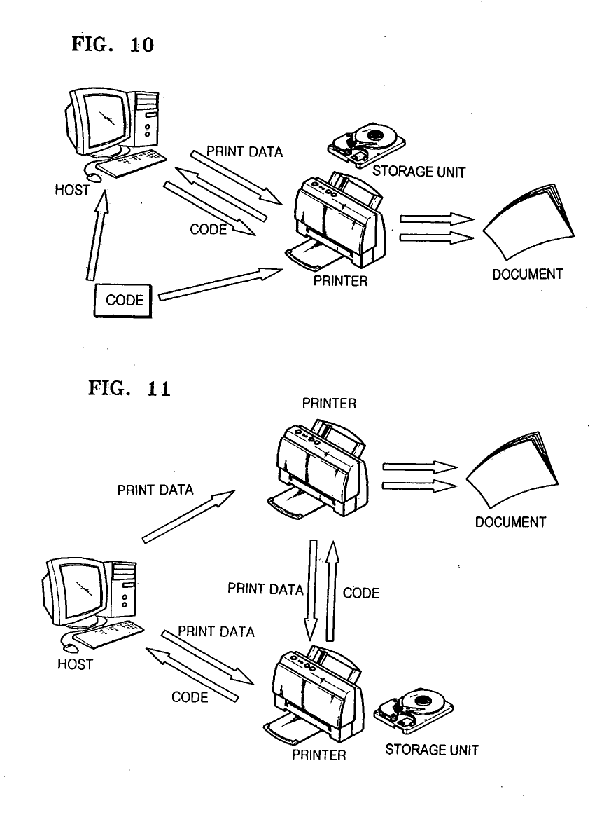

FIG. 10 is a diagram illustrating receiving of code by a printer having a storage unit and printing of a document by the printer, according to an exemplary embodiment of the present general inventive concept. Referring to FIG. 10, an input unit of a host or a printer receives code. The host or the printer analyses the received code, extracts device ID information, a network address, and document ID information from the received code, reads print data corresponding to the extracted document ID information from a device corresponding to the extracted network address and the extracted device ID information (e.g., the printer), and prints the read print data as a document. When the input unit of the printer initially receives the code (instead of the input unit of the host), the printer can transmit the code to the host, as illustrated in FIG. 10.

FIG. 11 is a diagram illustrating storing of a document in one printer having a storage unit of a plurality of printers and generating of code by the printer having the storage unit, according to an exemplary embodiment of the present general inventive concept. Referring to FIG. 11, a host generates print data and transmits the print data to the printer having the storage unit. Alternatively, the host transmits print data to the printer not having a storage unit, and the printer not having a storage unit transmits the print data to the printer having the storage unit. Then, the printer having the storage unit stores the print data therein, generates code, and transmits the code to the host and/or the printer not having a storage unit. The printer not having a storage unit adds the code to the print data and then prints the print data as a printed document.

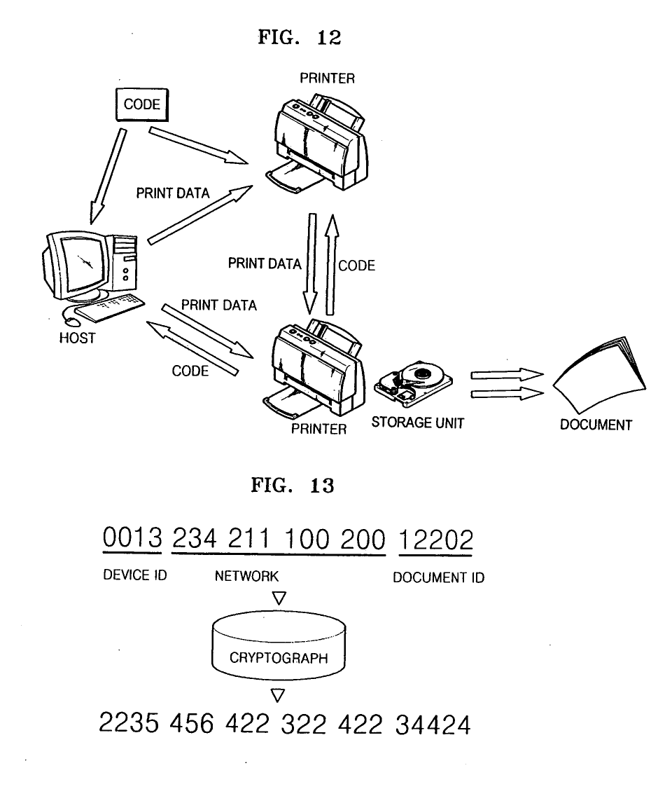

FIG. 12 is a diagram illustrating receiving of code by a host or a printer not having a storage unit and printing of a document (print data of the document) read from a printer having a storage unit, according to an exemplary embodiment of the present general inventive concept. Referring to FIG. 12, an input unit of the host or printer not having a storage unit receives code. The host or printer not having a storage unit analyzes the received code, extracts device ID information, a network address, and document ID information from the received code, reads print data corresponding to the extracted document ID information from a device corresponding to the extracted network address and the extracted device ID information (e.g., the printer having a storage unit). The printer having the storage unit stores the print data therein, generates code, transmits the code to the host and/or the printer not having a storage unit, and prints the read print data as a document.

FIG. 13 is a diagram illustrating generating of code information into which storage information is encrypted, according to an exemplary embodiment of the present general inventive concept. Referring to FIG. 13, the storage information includes device ID information, network information, and document ID information, and the device ID information, the network information, and the document ID information are encrypted into an encrypted code. The encrypted code can then be used as a tracking code.

According to various other embodiments of the present general inventive concept, a system to store and output data using a network may include a storage unit connected to the network to store the data and to generate storage information corresponding to the stored data, a control unit to control transmission of the stored data based on the storage information, and an output unit to output the data based on the storage information. The storage unit may include at least one of a host, a server, a printer, a facsimile machine, and a scanner. The storage information may include a function field to indicate whether to transmit the data and how to transmit the data, a storage field to indicate whether to store the data, and a tracking code to indicate a location of the data.

The function field may include a first setting to indicate that the data is not to be transmitted, a second setting to indicate that the data is to be transmitted using a printer, a third setting to indicate that the data is to be transmitted using a facsimile line, or a fourth setting to indicate that the data is to be transmitted to a device in response to a request from the device for the data. The storage field may include a first setting to indicate that the storage field is not used, a second setting to indicate that the data is to be stored in the storage unit, a third setting to indicate that the data is not to be stored in the storage unit, or a fourth setting to indicate that the storage unit is used to search for the data and to transmit the data to a device in response to a request from the device for the data. The tracking code may include first information to identify a device storing the data, second information to identify the data, and third information to identify a network address of the device storing the data.

According to various other embodiments of the present general inventive concept, a method of storing and outputting data using a network that may include transmitting print data and corresponding storage information to a storage unit, storing the print data in the storage unit and generating a tracking code corresponding to the stored print data, transmitting the tracking code to at least one network device, and outputting the print data using an output device. The at least one network device may be a host or a printer. The output device may include the storage unit. The output device may be the at least one network device.

According to various other embodiments of the present general inventive concept, a method of outputting data using a network may include receiving and analyzing a tracking code associated with print data to be printed, locating the print data to be printed from a storage unit using the tracking code, and outputting the print data to be printed using an output device. The output device may include the storage unit.

The present general inventive concept can also be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that a computer-readable code is written thereto and executed therefrom in a decentralized manner. Functional programs, code, and code segments needed for realizing the present general inventive concept can be easily envisioned by one of ordinary skill in the art.

As described above, according to the present general inventive concept, it is possible to read a document or print data from a device other than a host issuing a print command or a printing device and output the document or print data using the printing device by storing the document or print data in the device together with storage information.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A system to store and output print data using a network, comprising:
a storage unit to store storage information that comprises the print data and a tracking code of the storage information specifying a location of the storage information;
an interface unit to transmit or receive the print data and the storage information;
a control unit to issue a request for the print data through the interface unit using the tracking code of the storage information and to control the receiving of the print data through the interface unit; and
an output unit to output the print data.

2. The system of claim 1, wherein the tracking code is code into which device identification information, a network address specifying a device storing the print data, and document identification information specifying a document containing the print data are encoded.

3. The system of claim 2 further comprising:
an input unit to receive the code,
wherein the input unit manually or automatically receives the code.

4. The system of claim 3, wherein the input unit receives the code by automatically reading the code using a scanner.

5. The system of claim 3 further comprising:
an extraction unit to extract the device identification information, the network address, and the document identification information from the received code when the code is received,
wherein the control unit issues a request for a document corresponding to the extracted document identification information to a device corresponding to the extracted network address and the extracted device identification information and controls the requested document to be received by the interface unit.

6. The system of claim 1, wherein:
the storage information further comprises a function field specifying how to handle the print data; and
the output unit determines whether to print the print data or transmit the print data using a facsimile line with reference to the function field.

7. The system of claim 1 further comprising:
a host to generate storage information that comprises the print data, a function field specifying how to handle the print data, a storage field specifying whether the print data is stored, and the tracking code specifying the location of the print data,
wherein the storage unit stores the print data and the storage information in a location specified by the storage field.

8. The system of claim 7, wherein the host generates the storage information using one of a printer driver and an application program.

9. The system of claim 2, wherein the output unit outputs the code together with the print data.

10. A method of storing and outputting print data using a network, comprising:
storing storage information that comprises print data and tracking code of the storage information specifying the location of the storage information;
issuing a request for the print data with reference to the tracking code and controlling a receiving of the print data; and
outputting the print data.

11. The method of claim 10, wherein the tracking code is code into which device identification information, a network address specifying a device storing the print data, and document identification information specifying a document containing the print data are encoded.

12. The method of claim 11 further comprising manually or automatically receiving the code between the storing of the storing information and the issuing of the request for the print data.

13. The method of claim 12, wherein the automatically receiving the code comprises automatically reading the code using a scanner.

14. The method of claim 11 further comprising:
extracting device identification information, a network address, and document identification information from the received code between the storing of the storing information and the issuing of the request for the print data if the code is received,
wherein the issuing of the request for the print data comprises allowing a device corresponding to the extracted network address and the extracted device identification information to search for and read a document corresponding to the extracted document identification information.

15. The method of claim 10, wherein:
the storage information further comprises a function field specifying how to handle the print data, and
the outputting of the print data comprises printing the print data or transmitting the print data using a facsimile line with reference to the function field.

16. The method of claim 11, wherein the outputting of the print data comprises outputting the tracking code together with the print data.

17. A computer-readable recording medium storing a computer program to execute a method of storing and outputting print data using a network, the method comprising:
storing storage information that comprises print data and tracking code of the storage information specifying the location of the storage information;
issuing a request for the print data with reference to the tracking code and controlling a receiving of the print data; and
outputting the print data.

18. A system to store and output data using a network, comprising:
a storage unit connected to the network to store the data and to generate storage information corresponding to the stored data;
a control unit to control transmission of the stored data based on the storage information; and
an output unit to output the data based on the storage information.

19. A method of storing and outputting data using a network, comprising:
generating storage information corresponding to stored data;
analyzing identification and location information of input print data of a document to be printed;
determining whether the analyzed identification and location information corresponds to the storage information of the stored data; and
outputting the stored data when the analyzed identification and location information corresponds to the storage information of the stored data.

20. A method of storing and outputting data using a network, comprising:
transmitting print data and corresponding storage information to a storage unit;
storing the print data in the storage unit and generating a tracking code corresponding to the stored print data;
transmitting the tracking code to at least one network device; and
outputting the print data using an output device.
